(19) United States
(12) Patent Application Publication
(10) Pub. No.: US 2021/0361985 A1
(43) Pub. Date: Nov. 25, 2021

(54) Pocket Mask

(71) Applicant: Corey Garmon, Spokane, WA (US)

(72) Inventor: Corey Garmon, Spokane, WA (US)

(21) Appl. No.: 16/991,986

(22) Filed: Aug. 12, 2020

Related U.S. Application Data
(60) Provisional application No. 63/026,969, filed on May 19, 2020.

(51) Int. Cl. A62B 23/02; A41D 13/11

(52) U.S. Cl. CPC A62B 23/025; A41D 13/113

(57) ABSTRACT

The pocket mask apparatus is a readily carriable respiratory mask. The pocket mask apparatus contains a respiratory mask and a mask pouch. The respiratory mask contains a mask body and at least one strap. The mask body contains at least one folding seam. The mask pouch contains a pouch body, a mask cavity, and a pouch opening. The respiratory mask is positioned within the mask pouch. The mask body is configured to fold about the at least one folding seam into a folded configuration. Each of the at least one strap is terminally connected to the mask body. Each of the at least one strap is positioned opposite to each other along the mask body. The mask cavity traverses into the pouch body. The mask cavity is delineated by the pouch opening. The mask cavity is configured to receive the respiratory mask in the folded configuration through the pouch opening.

The current application claims a priority to the U.S. Provisional Patent application Ser. No. 63/026,969 filed on May 19, 2020.

### FIELD OF THE INVENTION

The present invention generally relates to hygiene. More specifically, the present invention relates to a device for protecting a user from germs and pollution.

### BACKGROUND OF THE INVENTION

A device that protects a person from germs is in demand. Many people, including health care professionals, wear face masks to protect patients as well as the wearer. Face masks protects the wearer from contracting infections via bacteria or viral particles. However, such masks are generally made of flexible material to fit the wearer's face and usually are not easy to carry without damaging their shape. For example, when the user wishes to carry a flexible face mask in a container (e.g., a purse or bag), the mask can be wrinkled or damaged through contact with other items in it or through movements of the wearer that may continuously change the shape of the container.

Wearing face masks is preferred in many instances to prevent people from infectious diseases. Many people cough or sneeze into their hands, which thus become covered with germs. As a result, infected people can transfer germs to other people by touching commonly used things with their hands.

Infection experts recommend that people use their arms to catch sneezes and coughs, such as by using the crook of the arm, or inner elbow, to prevent the spread of germs. However, this method does not solve the problem of having one's clothing or arms covered with germs, including sputum (mucus, phlegm, and other such matter). Not only can this be unpleasant to people, but it also still allows transfer of germs to others who touch the person in the area of the arm that is covered by germs.

Although use of the arms to catch germs may avoid coughing directly into the hands, pathogens may later be transferred to the hands or otherwise conveyed to others. People can use tissues to clean the arms or cover the mouth and nose when coughing or sneezing, but tissues are not always readily available. People can wear surgical masks to keep from spreading germs to others, but masks are not always easy to carry without damaging them and can be easily lost. Thus, there is a need for a device that solves these problems.

The present invention is intended to address problems associated with and/or otherwise improve on conventional devices through an innovative face mask device that is designed to provide a convenient means of carrying while incorporating other problem-solving features.

### SUMMARY OF THE INVENTION

The present invention is a pocket mask apparatus. The pocket mask apparatus comprises a respiratory mask and a mask pouch. The respiratory mask comprises a mask body and at least one strap. The mask body comprises at least one folding seam. The mask pouch comprises a pouch body, a mask cavity, and a pouch opening. The respiratory mask is positioned within the mask pouch. The mask body is configured to fold about the at least one folding seam into a folded configuration. Each of the at least one strap is terminally connected to the mask body. Each of the at least one strap is positioned opposite to each other along the mask body. The mask cavity traverses into the pouch body. The mask cavity is delineated by the pouch opening. The mask cavity is configured to receive the respiratory mask in the folded configuration through the pouch opening. In the preferred embodiment of the present invention, the mask pouch is rectilinear in shape. In the preferred embodiment of the present invention, the mask body is rectilinear in shape. In the preferred embodiment of the present invention, the pocket mask apparatus is sufficiently flat and compact to fit in to a wallet. This allows the user to readily deploy the respiratory mask at any necessary time.

### BRIEF DESCRIPTION OF THE DRAWINGS

FIG. 1 is an illustration of the present invention stored within a wallet.

FIG. 2 is an illustration of the present invention.

FIG. 3 is an illustration of the present invention that shows a folded respiratory mask pulled out of a pouch body.

FIG. 4 is an illustration of the present invention that shows the respiratory mask in its unfolded configuration.

FIG. 5 is an illustration of the present invention that shows the respiratory mask worn on a user.

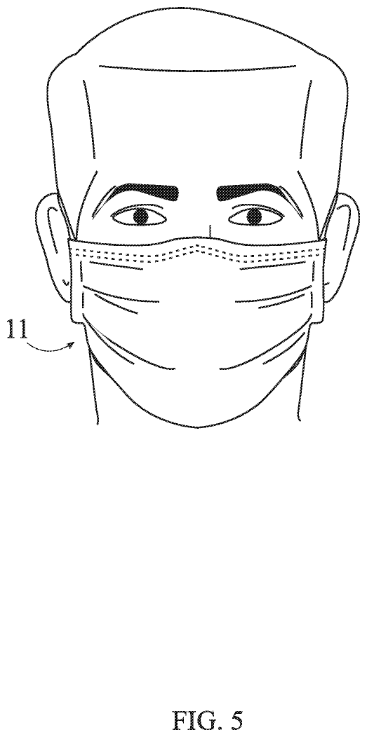

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

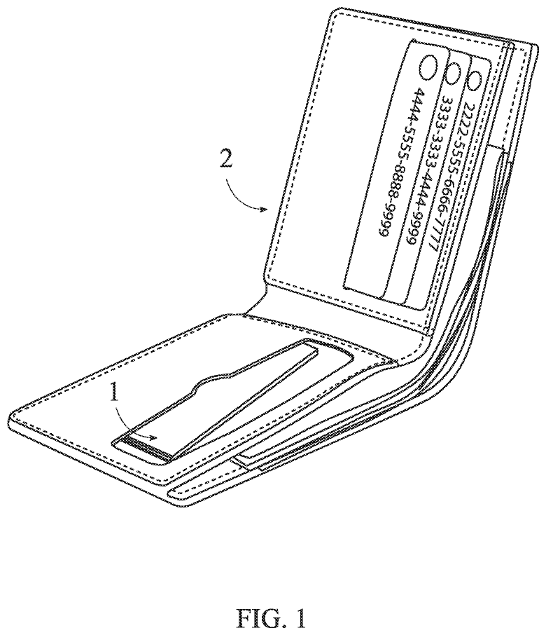

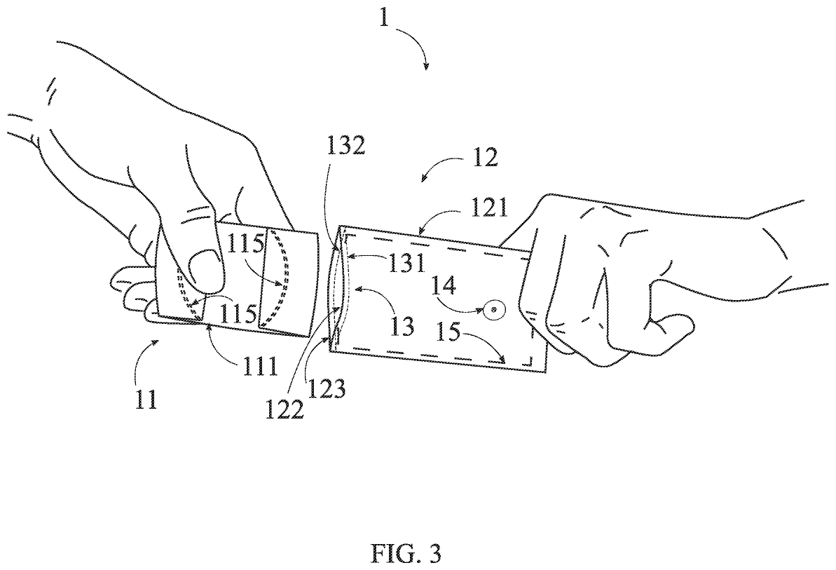

The present invention is a pocket mask apparatus 1 as shown in FIGS. 1-3. The pocket mask apparatus 1 comprises a respiratory mask 11 and a mask pouch 12. The respiratory mask 11 comprises a mask body 111 and at least one strap 115. The mask body 111 comprises at least one folding seam 112. The mask pouch 12 comprises a pouch body 121, a mask cavity 122, and a pouch opening 123. The respiratory mask 11 is positioned within the mask pouch 12. The mask body 111 is configured to fold about the at least one folding seam 112 into a folded configuration, as shown in FIG. 3. Each of the at least one strap 115 is terminally connected to the mask body 111. Each of the at least one strap 115 is positioned opposite to each other along the mask body 111. The mask cavity 122 traverses into the pouch body 121. The mask cavity 122 is delineated by the pouch opening 123. The mask cavity 122 is configured to receive the respiratory mask 11 in the folded configuration through the pouch opening 123. In the preferred embodiment of the present invention, the mask pouch 12 is rectilinear in shape. In the preferred embodiment of the present invention, the mask pouch may take the form of different shapes. In another embodiment, the mask pouch is configured to fold over such that the mask pouch is more compact. In the preferred embodiment of the present invention, the mask body 111 is rectilinear in shape. In the preferred embodiment of the present invention, the pocket mask apparatus 1 is sufficiently flat and compact to fit in to a wallet 2, purse, pocket, or any other device as shown in FIG. 1. This allows the user to readily deploy the respiratory mask 11 at any necessary time. In the preferred embodiment of the present invention, the pocket mask apparatus 1 is made out of disposable materials, such as, but not limited to cotton, paper, cardboard, recyclables, plastics, or any other suitable material. In another embodiment, the pocket mask apparatus 1 is made out of any other suitable material, such that the pocket mask apparatus 1 is re-usable. In the preferred embodiment of the present invention, the respiratory mask 11 may take the form of any suitable type of mask that is sufficient in blocking and filtering particulates such as, but not limited to n95 masks, medically approved masks, or any other suitable mask.

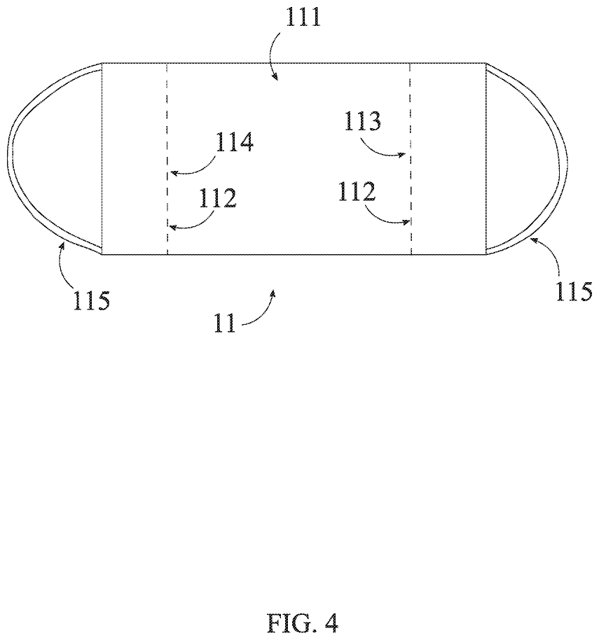

In reference to FIG. 4, the mask body 111 comprises a first folding seam 113 and a second folding seam 114. The first folding seam 113 and the second folding seam 114 laterally traverses across the mask body 111. The first folding seam 113 and the second folding is longitudinally spaced apart from each other along the mask body 111. The mask body 111 is configured to fold about the first folding seam 113 and the second folding seam 114 into the folded configuration, as shown in FIG. 3. In the preferred embodiment of the present invention, the first folding seam 113 and the second folding seam 114 may take the form of any other type of folding configuration.

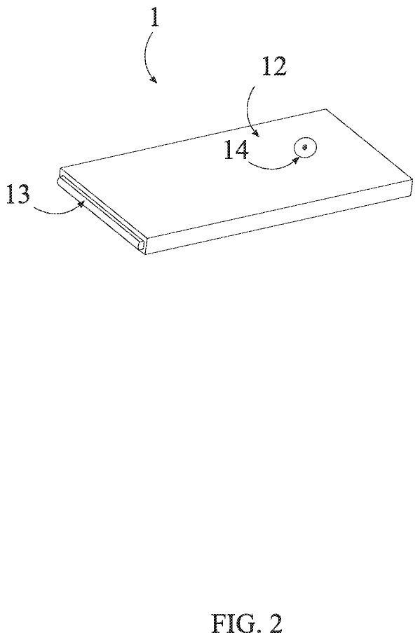

The pocket mask apparatus 1 further comprises a pouch seal 13, as shown in FIGS. 2-3. The pouch seal 13 is perimetrically positioned around the pouch opening 123. The pouch seal 13 comprises a first coupling strip 131 and a second coupling strip 132. The first coupling strip 131 and the second coupling strip 132 is perimetrically attached to the pouch opening 123. The first coupling strip 131 and the second coupling strip 132 is positioned opposite to each other along the pouch opening 123. The first coupling strip 131 and the second coupling strip 132 is removably attached to each other, where the mask pouch 12 is releasably sealed through the first coupling strip 131 and the second coupling strip 132. In the preferred embodiment of the present invention, the first coupling strip 131 and the second coupling strip 132 may take the form of a resealable adhesive fastener, but may take the form of any other suitable type of fastener, such as, but not limited to locking strips, clips, or any other suitable type of fastener. In another embodiment of the present invention, the pouch seal 13 is a perforated seam that allows the user to rip open the mask pouch 12 to access the respiratory mask 11.

In the preferred embodiment of the present invention, the pocket mask apparatus 1 further comprises a check valve 14, as shown in FIGS. 2-3. The check valve 14 is attached to the pouch body 121. The check valve 14 is in fluid communication with the mask cavity 122. The check valve 14 may take the form of a one-way air-valve that allows air to permeate out of the mask pouch 12, such that the mask cavity 122 is under vacuum. In the preferred embodiment of the present invention, the pocket mask apparatus 1 further comprises a sterilization layer 15, as shown in FIG. 3. The sterilization layer 15 is positioned adjacent to the mask cavity 122. The sterilization layer 15 is infused with a sterilization agent 16. The sterilization agent 16 may take the form of any type of antiseptic sufficient in disinfecting the respiratory mask 11, such as, but not limited to UV LED sheets, heated pads, disinfectant, or any other suitable type of sterilization agent 16.

Although the invention has been explained in relation to its preferred embodiment, it is to be understood that many other possible modifications and variations can be made without departing from the spirit and scope of the invention as hereinafter claimed.

What is claimed is:

1. A pocket mask apparatus comprising:
a respiratory mask;
a mask pouch;
the respiratory mask comprising a mask body and at least one strap.
the mask body comprising at least one folding seam;
the mask pouch comprising a pouch body, a mask cavity, and a pouch opening;
the respiratory mask being positioned within the mask pouch;
the mask body being configured to fold about the at least one folding seam into a folded configuration;
each of the at least one strap being terminally connected to the mask body;
each of the at least one strap being positioned opposite to each other along the mask body;
the mask cavity traversing into the pouch body;
the mask cavity being delineated by the pouch opening; and
the mask cavity being configured to receive the respiratory mask in the folded configuration through the pouch opening.

2. The pocket mask apparatus as claimed in claim 1 comprising:
the mask body comprising a first folding seam and a second folding seam;
the first folding seam and the second folding seam laterally traversing across the mask body;
the first folding seam and the second folding being longitudinally spaced apart from each other along the mask body; and
the mask body being configured to fold about the first folding seam and the second folding seam into the folded configuration.

3. The pocket mask apparatus as claimed in claim 1 comprising:
a pouch seal; and
the pouch seal being perimetrically positioned around the pouch opening.

4. The pocket mask apparatus as claimed in claim 3 comprising:
the pouch seal comprising a first coupling strip and a second coupling strip;
the first coupling strip and the second coupling strip being perimetrically attached to the pouch opening;
the first coupling strip and the second coupling strip being positioned opposite to each other along the pouch opening; and
the first coupling strip and the second coupling strip being removably attached to each other, wherein the mask pouch is releasably sealed through the first coupling strip and the second coupling strip.

5. The pocket mask apparatus as claimed in claim 3, wherein the pouch seal is a perforated seam.

6. The pocket mask apparatus as claimed in claim 1 comprising:
a check valve;
the check valve being attached to the pouch body; and
the check valve being in fluid communication with the mask cavity.

7. The pocket mask apparatus as claimed in claim 1 comprising:
a sterilization layer;
the sterilization layer being positioned adjacent to the mask cavity; and
the sterilization layer being infused with a sterilization agent.

8. The pocket mask apparatus as claimed in claim 1, wherein the mask pouch is rectilinear in shape.

9. The pocket mask apparatus as claimed in claim 1, wherein the mask body is rectilinear in shape.
